(19) United States
(12) Patent Application Publication
(10) Pub. No.: US 2020/0223259 A1
(43) Pub. Date: Jul. 16, 2020

(54) TIRE PROVIDED WITH AN OUTER SIDEWALL, THE COMPOSITION OF WHICH COMPRISES A HYDROCARBON RESIN

(71) Applicant: COMPAGNIE GENERALE DES ETABLISSEMENTS MICHELIN, Clermont-Ferrand (FR)

(72) Inventors: FABIEN HELLOT, Clermont-Ferrand (FR); SYLVAIN MAYER, Clermont-Ferrand (FR); FLORIAN DULONG, Clermont-Ferrand (FR)

(21) Appl. No.: 16/626,958

(22) PCT Filed: Jun. 27, 2018
(86) PCT No.: PCT/FR2018/051572

§ 371 Date: Dec. 27, 2019

(30) Foreign Application Priority Data
Jun. 29, 2017 (FR) 1756033

(51) Int. Cl. B60C 1/00; C08L 9/00; C08L 7/00

(52) U.S. Cl. CPC B60C 1/0025; C08L 2205/03; C08L 7/00; C08L 9/00

(57) ABSTRACT

A tire is provided with an external sidewall, the said external sidewall comprising at least one composition based on at least from 30 to 60 phr of isoprene elastomer, from 40 to 70 phr of butadiene elastomer, from 10 to 70 phr of carbon black, from 5 to 25 phr of hydrocarbon resin predominantly composed of units resulting from C₅ monomers, from 1.2 to 10 phr of anti-ozone wax, and a crosslinking system.

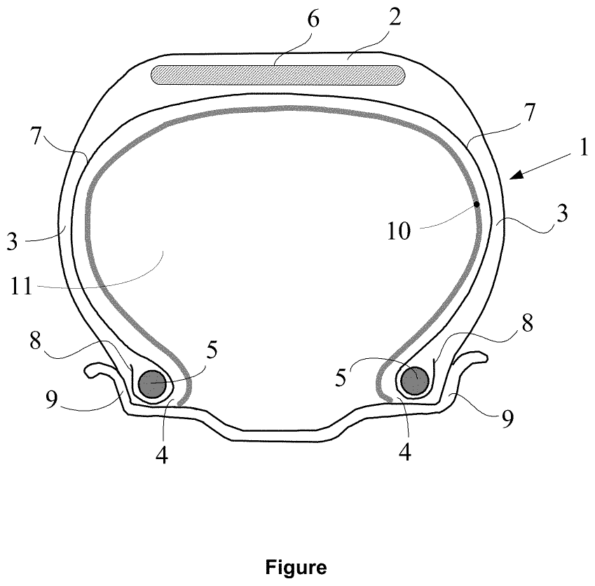

The present invention relates to pneumatic tyres and more particularly to tyre external sidewalls, that is to say, by definition, to the elastomeric layers located radially on the outside of the tyre, which are in contact with the ambient air.

This is because it is possible to define, within the tyre, three types of regions:
The radially exterior region in contact with the ambient air, this region being essentially composed of the tread and of the external sidewall of the tyre. An external sidewall is an elastomeric layer positioned outside the carcass reinforcement with respect to the internal cavity of the tyre, between the crown and the bead, so as to completely or partially cover the region of the carcass reinforcement extending from the crown to the bead.
The radially interior region in contact with the inflation gas, this region generally being composed of the layer airtight to the inflation gases, sometimes known as inner liner.
The internal region of the tyre, that is to say that between the exterior and interior regions. This region includes layers or plies which are referred to here as internal layers of the tyre. These are, for example, carcass plies, tread underlayers, tyre belt plies or any other layer which is not in contact with the ambient air or the inflation gas of the tyre.

For tyre manufacturers, the composition of a tyre sidewall has to exhibit numerous characteristics which are sometimes difficult to reconcile and in particular a good ozone resistance, a low rolling resistance and a plasticity before curing which makes the tyre easy to manufacture (processability).

As illustrated by numerous documents, among which may be mentioned the documents EP 1 097 966, EP 1 462 479 B1, EP 1 975 200 A1, EP 1 033 265 B1, EP 1 357 149 A2, EP 1 231 080 A1 and U.S. Pat. No. 4,824,900, the compositions conventionally used for sidewalls are based on natural rubber and on synthetic rubber, such as polybutadiene, and on carbon black.

The anti-ozone wax exhibits the disadvantage of migrating towards the outside of the sidewalls, resulting in the appearance of whitish stains which damage the attractiveness of the tyres. This phenomenon is known as efflorescence. It is thus advantageous for tyre manufacturers to have available sidewall compositions exhibiting simultaneously the technical properties of ozone resistance, of low rolling resistance and of processability, without the efflorescence damaging the attractiveness of the tyre sidewalls.

In this context, a solution introduced by the Applicant Companies which makes it possible to obtain tyres which exhibit the technical and aesthetic properties discussed above consists in using novel sidewall compositions as explained below.

A subject-matter of the invention proposed is now a tyre provided with an external sidewall, the said external sidewall comprising at least one composition based on at least from 30 to 60 phr of isoprene elastomer, from 40 to 70 phr of butadiene elastomer, from 10 to 70 phr of carbon black, from 5 to 25 phr of hydrocarbon resin predominantly composed of units resulting from C₅ monomers, from 1.2 to 10 phr of anti-ozone wax, and a crosslinking system.

The invention relates more particularly to the pneumatic tyres intended to equip motor vehicles of passenger vehicle type, SUVs (“Sport Utility Vehicles”), or two-wheel vehicles (in particular motorcycles), or aircraft, or also industrial vehicles chosen from vans, heavy-duty vehicles—that is to say, underground trains, buses, heavy road transport vehicles (lorries, tractors, trailers) or off-road vehicles, such as heavy agricultural vehicles or earthmoving equipment —, and other transportation or handling vehicles.

The invention and its advantages will be easily understood in the light of the description and implementational examples which follow, and also of the single figure relating to these examples, which diagrammatically represents, in radial cross section, a pneumatic tyre in accordance with the invention.

### I. DETAILED DESCRIPTION OF THE INVENTION

The expression “composition based on” should be understood as meaning a composition comprising the mixture and/or the product of the in situ reaction of the various base constituents used, some of these constituents being able to react and/or being intended to react with one another, at least partially, during the various phases of manufacture of the composition or during the subsequent curing, modifying the composition as it is prepared at the start. Thus, the compositions as employed for the invention can be different in the non-crosslinked state and in the crosslinked state.

Moreover, the term “phr” means, within the meaning of the present patent application, parts by weight per hundred parts of elastomers, in a way well known to a person skilled in the art.

In the present description, unless expressly indicated otherwise, all the percentages (%) shown are percentages by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

When reference is made to a “predominant” compound, this is understood to mean, within the meaning of the present invention, that this compound is predominant among the compounds of the same type in the composition, that is to say that it is the one which represents the greatest amount by weight among the compounds of the same type. Thus, for example, a predominant polymer is the polymer representing the greatest weight, with respect to the total weight of the polymers in the composition. In the same way, a “predominant” filler is the one representing the greatest weight among the fillers of the composition. By way of example, in a system comprising just one polymer, the latter is predominant within the meaning of the present invention and, in a system comprising two polymers, the predominant polymer represents more than half of the weight of the polymers. On the contrary, a “minor” compound is a compound which does not represent the greatest fraction by weight among the compounds of the same type.

Within the meaning of the present invention, when reference is made to a “predominant” unit (or monomer) within one and the same compound (or polymer), this is understood to mean that this unit (or monomer) is predominant among the units (or monomers) forming the compound (or polymer), that is to say that it is the one which represents the greatest fraction by weight among the units (or monomers) forming the compound (or polymer). Thus, for example, a resin predominantly composed of units resulting from C₅ monomers is a resin in which the C₅ units represent the greatest amount by weight among all the units making up the said resin. In other words, a “predominant” monomer or an assembly of “predominant” monomers is a monomer (or an assembly of monomers) which represents the greatest fraction by weight in the polymer. On the contrary, a “minor” monomer is a monomer which does not represent the greatest molar fraction in the polymer.

The compounds mentioned in the description can be of fossil or biobased origin. In the latter case, they can partially or completely result from biomass or be obtained from renewable starting materials resulting from biomass. Polymers, plasticizers, fillers, and the like, are concerned in particular.

### External Sidewall Elastomer Composition

The tyre according to the invention has the essential characteristic of being provided with an external sidewall, the said external sidewall comprising at least one composition based on at least from 30 to 60 phr of isoprene elastomer, from 40 to 70 phr of butadiene elastomer, from 10 to 70 phr of carbon black, from 5 to 25 phr of hydrocarbon resin predominantly composed of units resulting from C₅ monomers, from 1.2 to 10 phr of anti-ozone wax, and a crosslinking system.

Elastomers

As is customary, the terms “elastomer” and “rubber”, which are interchangeable, are used without distinction in the text.

“Diene” elastomer or rubber should be understood, in a known way, as meaning an (one or more is understood) elastomer resulting at least in part (i.e.; a homopolymer or a copolymer) from diene monomers (monomers carrying two conjugated or non-conjugated carbon-carbon double bonds).

These diene elastomers can be classified into two categories: “essentially unsaturated” or “essentially saturated”.

“Essentially unsaturated” is generally understood to mean a diene elastomer resulting at least in part from conjugated diene monomers having a content of units of diene origin (conjugated dienes) which is greater than 15% (mol %). In the category of “essentially unsaturated” diene elastomers, “highly unsaturated” diene elastomer is understood in particular to mean a diene elastomer having a content of units of diene origin (conjugated dienes) which is greater than 50%.

Thus it is that diene elastomers such as some butyl rubbers or copolymers of dienes and of α-olefins of EPDM type can be described as “essentially saturated” diene elastomers (low or very low content of units of diene origin, always less than 15%).

Given these definitions, essentially unsaturated diene elastomer capable of being used in the external sidewalls in accordance with the invention is understood more particularly to mean:

(a) any homopolymer obtained by polymerization of a conjugated diene monomer having from 4 to 12 carbon atoms;
b) any copolymer obtained by copolymerization of one or more conjugated dienes with one another or with one or more vinylaromatic compounds having from 8 to 20 carbon atoms.

For the requirements of the invention, the composition of the external sidewall comprises from 30 to 60 phr of isoprene elastomer and from 40 to 70 phr of butadiene elastomer.

Isoprene elastomer is understood to mean all the elastomers predominantly composed of isoprene monomers. Preferably, the isoprene elastomer is selected from the group consisting of isoprene polymers, isoprene copolymers and their mixtures. Among isoprene copolymers, mention may be made of those comprising, as minor comonomer, styrene (SIR), butadiene (BIR) or styrene and butadiene (SBIR).

Suitable, for example, are all isoprene/styrene copolymers and in particular those having a styrene content of between 5% and 50% by weight and a Tg of between −25° C. and −50° C.; also suitable are butadiene/isoprene copolymers having an isoprene content of between 50% and 90% by weight and a Tg of −40° C. to −80° C. In the case of butadiene/styrene/isoprene copolymers, suitable as isoprene elastomer are those having an isoprene content which is greater than the styrene and butadiene content, and in particular those having an isoprene content of between 50% and 60% by weight.

More preferably, the isoprene elastomer is selected from the group consisting of natural rubber (NR), synthetic polyisoprenes (IR) and their mixtures. Very preferably, the isoprene elastomer is natural rubber.

Use is preferably made, among synthetic polyisoprenes, of polyisoprenes having a content (mol %) of cis-1,4-bonds of greater than 90%, more preferably still of greater than 98%.

Preferably, the content of isoprene elastomer is within a range extending from 30 to 55 phr, preferably from 35 to 50 phr.

Butadiene elastomer is understood to mean all the elastomers predominantly composed of butadiene monomers. Preferably, the butadiene elastomer is selected from the group consisting of butadiene polymers, butadiene copolymers and their mixtures. Among butadiene copolymers, mention may be made of those comprising, as minor comonomer, styrene (SBR), isoprene (BIR) or styrene and isoprene (SBIR).

All polybutadienes are suitable and in particular those having a content (mol %) of 1,2-units of between 4% and 80% or those having a cis-1,4-content (mol %) of greater than 80%.

Also suitable are all butadiene/styrene copolymers and in particular those having a glass transition temperature, Tg, (measured according to ASTM D3418) of between 0° C. and −70° C. and more particularly between −10° C. and −60° C., a styrene content of between 5% and 60% by weight and more particularly between 20% and 50%, a content (mol %) of 1,2-bonds of the butadiene part of between 4% and 75% and a content (mol %) of trans-1,4-bonds of between 10% and 80%.

Also suitable are butadiene/isoprene copolymers, those having an isoprene content between 5% and 50% by weight and a Tg of −40° C. to −80° C.

In the case of butadiene/styrene/isoprene copolymers, suitable as butadiene elastomer are in particular those having a butadiene content which is greater than the styrene and isoprene content.

More preferably, the butadiene elastomer is selected from the group consisting of polybutadiene (BR), butadiene/styrene copolymers (SBRs) and their mixtures. Very preferably, the butadiene elastomer is polybutadiene.

Preferably, the content of butadiene elastomer is within a range extending from 45 to 70 phr, preferably from 50 to 65 phr.

Preferably, for the invention, the isoprene and butadiene elastomers are the only elastomers of the composition, which means that the sum of their contents in phr is 100 phr.

Alternatively, complementarily, the composition of the external sidewall of the tyre of the invention can comprise other elastomers, this being the case at a content preferably of less than or equal to 30 phr, preferably at a content of less than or equal to 25 phr, 20 phr, indeed even 15 phr.

Use may be made, as such, of any elastomer known to a person skilled in the art which is not defined above as isoprene or butadiene elastomer.

Carbon Black and Fillers

The composition of the external sidewall of the tyre of the invention comprises from 10 to 70 phr of carbon black.

Use may be made of any type of carbon black known for its abilities to reinforce a rubber composition which can be used in the manufacture of tyres.

All the carbon blacks conventionally used in tyres (“tyre-grade” blacks) are suitable as carbon blacks. Mention will more particularly be made, for example, of the reinforcing carbon blacks of ASTM grade N115, N134, N234, N326, N330, N339, N347 or N375, or else, depending on the applications targeted, the blacks of higher series (for example N550, N660, N683 or N772), indeed even N990.

In the case of the use of carbon blacks with an isoprene elastomer, the carbon blacks might, for example, be already incorporated in the isoprene elastomer in the form of a masterbatch (see, for example, Applications WO 97/36724 or WO 99/16600).

Preferably, for the invention, use may be made of a carbon black having a high specific surface. Specific surface is understood here to mean the BET specific surface measured according to Standard ASTM D6556-09 [multipoint (5 point) method—gas: nitrogen—relative pressure p/po range: 0.05 to 0.30].

Thus, for the requirements of the invention, in the composition of the external sidewall, from 10 to 70 phr of the carbon black, preferably from 10 to 45 phr, exhibits a specific surface of greater than 60 m²/g, preferably of greater than 80 m²/g. More preferably, from 10 to 70 phr of the carbon black, preferably from 10 to 45 phr, exhibits a specific surface of greater than 90 m²/g, preferably of greater than 110 m²/g.

Preferably, in the composition of the external sidewall of the tyre of the invention, the total amount of carbon black is within a range extending from 20 to 60 phr, preferably from 25 to 55 phr.

Preferably, for the invention, the carbon black is the only reinforcing filler in the composition of the external sidewall of the tyre, preferably the only filler.

Alternatively and complementarily, the composition of the external sidewall of the tyre of the invention can comprise another filler, optionally a reinforcing filler, preferably at a total content of less than 20 phr, more preferably of less than 15 phr.

Suitable as such are organic fillers other than carbon black, reinforcing inorganic fillers or also non-reinforcing fillers.

Mention may be made, as examples of organic fillers other than carbon blacks, of functionalized polyvinylaromatic organic fillers, such as are described in Applications WO-A-2006/069792 and WO-A-2006/069793.

Mineral fillers of the siliceous type, especially silica (SiO₂), or of the aluminous type, especially alumina (Al₂O₃), are suitable in particular as reinforcing inorganic fillers. The silica used can be any reinforcing silica known to a person skilled in the art, in particular any precipitated or fumed silica exhibiting a BET specific surface and also a CTAB specific surface both of less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface as described in Application WO 03/16837.

In order to couple the reinforcing inorganic filler to the diene elastomer, use is made, in a known way, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Mention may be made, as non-reinforcing filler, of those selected from the group consisting of calcium carbonate, kaolin, montmorillonite, aluminium silicate, magnesium silicate and their mixtures.

Plasticizers—Resin and Oil

Resins

The composition of the external sidewall of the tyre of the invention comprises from 5 to 25 phr of hydrocarbon resin predominantly composed of units resulting from C₅ monomers.

This is because the Applicant Companies have found that such an amount of such a resin makes it possible for the tyre sidewall compositions to exhibit an excellent balance in performance qualities of ozone resistance, of non-efflorescence or absence of efflorescence, of low rolling resistance and of processability of the tyre.

C₅ monomers is understood to mean, according to the present invention and conventionally for a person skilled in the art, the monomers resulting from C₄ to C₆ oil cuts. For example, cis- and trans-1,3-pentadienes, pentenes, cyclopentadiene, cyclopentene, piperylene, isoprene, and the like, are suitable.

The resin of use for the requirements of the invention, predominantly composed of units resulting from C₅ monomers, can comprise, in addition to these units and in a minor amount, aliphatic or aromatic units or else units of aliphatic/aromatic type, that is to say based on aliphatic and/or aromatic monomers, other than C₅ monomers. As such, the resin can comprise, in a minor amount, units resulting from C₉ monomers.

This hydrocarbon resin is predominantly composed of units resulting from C₅ monomers; the resin exhibits an aromatic proton content of less than 20%, preferably of less than 15%.

According to a preferred embodiment of the invention, the hydrocarbon resin of use for the requirements of the invention exhibits an aromatic proton content of less than 5%, preferably of less than 0.5%. More preferably, the resin does not comprise an aromatic unit.

According to another preferred embodiment of the invention, the hydrocarbon resin of use for the requirements of the invention exhibits an aromatic proton content within a range extending from 7% to 15%, preferably from 9% to 13%.

Preferably again, the hydrocarbon resin of use for the requirements of the invention exhibits an ethylenic proton content of less than 15%, preferably of less than 7%, more preferably of less than 5%.

According to a preferred embodiment, the hydrocarbon resin of use for the requirements of the invention exhibits a glass transition temperature (Tg) within a range extending from 30° C. to 80° C., preferably from 40° C. to 60° C.

The hydrocarbon resin of use for the requirements of the invention exhibits an average molecular mass Mn within a range extending from 500 g/mol to 3000 g/mol and preferably from 700 to 2000 g/mol.

Preferably, the hydrocarbon resin of use for the requirements of the invention exhibits a polydispersity index (PI) within a range extending from 1 to 4, preferably from 1.5 to 3.5, more preferably from 1.7 to 3.

Numerous hydrocarbon resins are available commercially. These resins may exhibit characteristics, in particular of chemical composition, of Tg, of Mn, of aromatic or ethylenic proton content or else of PI, which differ depending on the suppliers.

The macrostructure (Mw, Mn, PI and Mz) of the hydrocarbon resin is determined by size exclusion chromatography (SEC) on the basis of Standards ISO 16014 (Determination of average molecular mass and molecular mass distribution of polymers using size-exclusion chromatography), ASTM D5296 (Standard test method for molecular weight averages and molecular weight distribution of polystyrene by high performance size-exclusion chromatography) and DIN 55672 (Gel permeation chromatography).

For these measurements, the resin sample is dissolved in non-antioxidized tetrahydrofuran up to a concentration of 1.5 g/l. The solution is filtered with a Teflon filter with a porosity of 0.45 μm, using, for example, a single-use syringe fitted with a filter. A volume of 100 μl is injected through a set of size exclusion chromatography columns. The mobile phase is eluted with a flow rate of 1 ml/min. The columns are thermostatically controlled at 35° C. in an oven. Detection is carried out by a refractometer thermostatically controlled at 35° C. The stationary phase of the columns is based on a polystyrene/divinylbenzene gel having a controlled porosity. The polymer chains are separated according to the size which they occupy when they are dissolved in the solvent: the larger the volume they occupy, the less the pores of the columns are accessible to them and the shorter their elution time.

A Moore calibration curve connecting the logarithm of the molar mass (log M) with the elution time (et) is produced beforehand with polystyrene standards and modelled by a third degree polynomial: log(molar mass of polystyrene)=a+b et+c et2+d et3.

For the calibration curve, polystyrene standards with narrow molecular distributions are used (polydispersity index, PI, of less than or equal to 1.1). The range of molar masses of these standards extends from 160 to approximately 70 000 g/mol. These standards may be grouped together in “families” of 4 or 5 standards having a log M increment of approximately 0.55 between each family.

Use may be made of certified (ISO 13885 and DIN 55672) standard kits, such as, for example, the kits of vials from PSS (Polymer Standards Service, reference PSS-pskitr1l-3), and also an additional PS standard with Mp=162 g/mol (Interchim, reference 178952). These kits are provided in the form of 3 vials each containing a family of polystyrene standards in suitable amounts:
Black vial: Mp=1220, 4850, 15 500 and 67 500 g/mol.
Blue vial: Mp=376, 3470, 10 400 and 46 000 g/mol.
Yellow vial: Mp=266, 1920, 7200 and 28 000 g/mol.
PS162: Mp=162 g/mol.

The number-average molar mass (Mn), the weight-average molar mass (Mw), the Mz and the polydispersity of the resin analysed are calculated from this calibration curve. This is why molar masses relative to a polystyrene calibration are spoken of.

For the calculation of the average masses and of the PI, the limits of integration of the elution of the product are defined on the chromatogram corresponding to the injection of the sample. The refractometric signal defined between the two limits of integration is “cut” every second. For each of the “elementary cuts”, the elution time ti and the area of the signal from the detector Ai are read off.

It is recalled here that: PI=Mw/Mn, with Mw the weight-average molecular mass and Mn the number-average molecular mass. It is also recalled that the masses Mw, Mn and Mz are average masses calculated from the formulae below:

$$Mz = \frac{\sum Ai * {Mi}^{2}}{\sum Ai * Mi}$$

$$Mn = \frac{\sum Ai}{\sum \frac{Ai}{Mi}}$$

$$Mw = \frac{\sum Ai * Mi}{\sum Ai}$$

in which Ai is the amplitude of the signal from the refractometric detector corresponding to the mass Mi and to the elution time ti.

The equipment used for the SEC measurement is a liquid chromatography system, for example the Waters Alliance 2690 system comprising a pump, a degasser and an injector; a differential refractometer (for example the Waters 2410 refractometer), software for acquiring and processing the data, for example the Waters Empower software, a column oven, for example the Waters “Column Heater Module”, and 4 columns mounted in series in the following order:

| | | Range of | | | | | References |
|---|---|---|---|---|---|---|---|
| | | molar | | Internal | | | (for |
| | | masses | Length | diameter | Particle | | information |
| Number | Brand | (g/mol) | (mm) | (mm) | size (μm) | Trade name | only) |
| Columns | Polymer | 200-400000 | 300 | 7.5 | 5 | MIXED-D | PL1110-6504 |
| 1 and 2 | Laboratories | | | | | | |
| Columns | Polymer | 200-30000 | 300 | 7.5 | 3 | MIXED-E | PL1110-6300 |
| 3 and 4 | Laboratories | | | | | | |

The aromatic proton content (% AH) and the ethylenic proton content (% EH) are measured by ¹H NMR. This determination is carried out with respect to all of the signals detected. Thus, the results obtained are expressed as % of area of peak.

The samples are dissolved in deuterated chloroform (CDCl₃) at the rate of approximately 10 mg of resin in approximately 1 ml of solvent. The spectra are acquired on a Bruker Avance 500 MHz spectrometer equipped with a Bruker “broad band” BBO z-grad 5 mm probe. The ¹H NMR experiment uses a simple 30° pulse sequence and a repetition time of 5 seconds between each acquisition. 64 accumulations are carried out at ambient temperature. The chemical shifts are calibrated with respect to the protonated impurity of the deuterated chloroform; δ ppm ¹H at 7.20 ppm. The ¹H NMR signals of the aromatic protons are located between 8.5 ppm and 6.2 ppm. The ethylenic protons for their part give rise to signals between 6.2 ppm and 4.5 ppm. Finally, the signals corresponding to the aliphatic protons are located between 4.5 ppm and 0 ppm. The areas of each category of protons are referred to the sum of these areas to thus give a distribution in terms of % of area of each category of protons.

The glass transition temperature (Tg) is measured according to Standard ASTM D3418.

The C₅ resins are commercially available, for example sold by Eastman under the name Piccotac 1105 or Impera R1507, by Exxon under the name Escorez 1102, by Kolon under the name Hikorez A1100 or also by Cray Valley Total under the name Wingtack 98. The C₅-C₉ resins are commercially available, for example sold by Exxon under the name Oppera 373, by Eastman under the name Piccotac 8090 or by Cray Valley Total under the name Wingtack STS.

Preferably, in the composition of the external sidewall of the tyre of the invention, the amount of hydrocarbon resin is within a range extending from 7 to 25 phr, more preferably from 9 to 25 phr, or else from 8 to 20 phr, more preferably from 9 to 20 phr and very preferably from 9 to 18 phr.

Preferably, for the invention, the composition of the external sidewall of the tyre of the invention does not comprise another resin than the C₅ resin described above.

Alternatively, the composition can additionally comprise another hydrocarbon resin at a content of less than or equal to 15 phr, preferably of less than or equal to 10 phr.

Suitable as such are any type of hydrocarbon resin, sometimes also known as plasticizing resin or thermoplastic resin.

It is recalled here that the designation “resin” is reserved in the present patent application, by definition known to a person skilled in the art, for a compound which is solid at ambient temperature (23° C.), in contrast to a liquid plasticizing compound, such as an extender oil or plasticizing oil. At ambient temperature (23° C.), these oils, which are more or less viscous, are liquids (that is to say, as a reminder, substances which have the ability to eventually assume the shape of their container), in contrast in particular to resins or rubbers, which are by nature solids.

Hydrocarbon resins are polymers well known to a person skilled in the art, essentially based on carbon and hydrogen, which can be used in particular as plasticizing agents in polymer matrices. They have been described, for example, in the work entitled “Hydrocarbon Resins” by R. Mildenberg, M. Zander and G. Collin (New York, VCH, 1997, ISBN 3-527-28617-9), Chapter 5 of which is devoted to their applications, in particular in the tyre rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic, based or not based on petroleum (if such is the case, also known under the name of petroleum resins). They are by definition miscible (i.e., compatible) at the contents used with the polymer compositions for which they are intended, so as to act as true diluents. Their Tg is preferably greater than 0° C., in particular greater than 20° C. (most often between 30° C. and 120° C.).

In a known way, these hydrocarbon resins can also be described as thermoplastic resins in the sense that they soften when heated and can thus be moulded. They can also be defined by a softening point, the temperature at which the product, for example in the powder form, sticks together. The softening point of a hydrocarbon resin is generally greater by approximately 50 to 60° C. than its Tg value.

Mention may be made, as examples of such hydrocarbon resins, of those selected from the group consisting of terpene homopolymer or copolymer resins, terpene/phenol resins, C₉ cut homopolymer or copolymer resins, vinylaromatic homopolymer or copolymer resins and the mixtures of these resins.

The term “terpene” groups together here, in a known way, α-pinene, β-pinene and limonene monomers; use is preferably made of a limonene monomer, a compound which exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomer are, for example: styrene, α-methylstyrene, ortho-methyl styrene, meta-methyl styrene, para-methyl styrene, vinyltoluene, para(tert-butyl)styrene, methoxystyrenes, chlorostyrenes, hydroxystyrenes, vinylmesitylene, divinylbenzene, vinylnaphthalene or any vinylaromatic monomer resulting from a C₉ cut (or more generally from a C₈ to C₁₀ cut).

All the above resins are well known to a person skilled in the art and are commercially available, for example sold by DRT under the name Dercolyte as regards the polylimonene resins.

Plasticizing Oils

Preferably, for the invention, the composition of the external sidewall of the tyre of the invention does not comprise a plasticizing oil or comprises less than 25 phr of it.

Preferably, for the invention, the composition of the external sidewall of the tyre of the invention does not comprise a plasticizing oil.

Alternatively, the composition can comprise a plasticizing oil. In this case, the amount of plasticizing oil is preferentially within a range extending from more than 0 to 25 phr, preferably from 3 to 15 phr.

Any plasticizing oil, sometimes also known as extender oil, whether it is of aromatic or, preferably, non-aromatic nature, known for its plasticizing properties with regard to diene elastomers can be used. At ambient temperature (20° C.), these oils, which are more or less viscous, are liquids (that is to say, as a reminder, substances which have the ability to eventually assume the shape of their container), in contrast in particular to plasticizing hydrocarbon resins, which are by nature solids at ambient temperature.

Plasticizing oils selected from the group consisting of naphthenic oils (low or high viscosity, in particular hydrogenated or not), paraffinic oils, MES (Medium Extracted Solvates) oils, TDAE (Treated Distillate Aromatic Extracts) oils, mineral oils, vegetable oils, ether plasticizers, ester plasticizers, phosphate plasticizers, sulfonate plasticizers and the mixtures of these compounds are particularly suitable.

For example, mention may be made of those which contain between 12 and 30 carbon atoms, for example trioctyl phosphate. Mention may in particular be made, as examples of non-aqueous and water-insoluble ester plasticizers, of the compounds selected from the group consisting of trimellitates, pyromellitates, phthalates, 1,2-cyclohexanedicarboxylates, adipates, azelates, sebacates, glycerol triesters and the mixtures of these compounds. Mention may in particular be made, among the above triesters, of glycerol triesters, preferably predominantly composed (for more than 50%, more preferably for more than 80%, by weight) of an unsaturated C₁₈ fatty acid, that is to say selected from the group consisting of oleic acid, linoleic acid, linolenic acid and the mixtures of these acids. More preferably, whether it is of synthetic origin or natural origin (case, for example, of sunflower or rapeseed vegetable oils), the fatty acid used is composed for more than 50% by weight, more preferably still for more than 80% by weight, of oleic acid. Such triesters (trioleates) having a high content of oleic acid are well known; they have been described, for example, in Application WO 02/088238 as plasticizing agents in tyre treads.

Anti-Ozone Wax

The composition of the external sidewall of the tyre of the invention comprises from 1.2 to 10 phr of anti-ozone wax.

Anti-ozone waxes are well known to a person skilled in the art. These film-forming anti-ozonant waxes can, for example, be paraffinic waxes, microcrystalline waxes or mixtures of paraffinic and microcrystalline waxes. They consist of a mixture of linear alkanes and of non-linear alkanes (isoalkanes, cycloalkanes, branched alkanes) resulting from the refining of oil or from the catalytic hydrogenation of carbon monoxide (Fischer-Tropsch process) predominantly comprising chains of at least 20 carbon atoms.

All the anti-ozonant waxes known to a person skilled in the art can be used, including natural waxes, such as, for example, candelilla wax or carnauba wax. These waxes can, furthermore, be used as blends.

Mention may be made of the commercial waxes Varazon 4959 or Varazon 6500 or also Varazon 6810 from Sasol, Ozoace 0355 from Nippon Seiro, Negozone 9343 from H&R and H3841 from Yanggu Huatai.

Preferably, the anti-ozone wax contains from 50% to 75% of linear alkanes comprising from 30 carbon atoms to 38 carbon atoms, with respect to the total amount of linear alkanes.

Preferably, in the composition of the external sidewall of the tyre of the invention, the amount of anti-ozone wax is within a range extending from 1.3 to 5 phr, more preferably from 1.5 to 3 phr.

Crosslinking System

The crosslinking system can be a vulcanization system; it is preferably based on sulfur (or sulfur donor) and on a primary vulcanization accelerator. Additional to this vulcanization system are optionally various known secondary vulcanization accelerators or vulcanization activators (preferably for 0.5 to 5.0 phr each), such as zinc oxide, stearic acid, guanidine derivatives (in particular diphenylguanidine), and the like. The sulfur or a sulfur donor is used at a preferred content of between 0.5 and 10 phr, more preferably between 0.5 and 5.0 phr, for example between 0.5 and 3.0 phr, when the invention is applied to a tyre external sidewall. Mention may be made, among sulfur donors, for example, of alkylphenol disulfides (APDSs), such as, for example, para-(tert-butyl)phenol disulfide.

Use may be made, as (primary or secondary) accelerator, of any compound capable of acting as accelerator of the vulcanization of diene elastomers in the presence of sulfur, in particular accelerators of the thiazole type and their derivatives and accelerators of the thiuram and zinc dithiocarbamate types. These accelerators are more preferably selected from the group consisting of 2-mercaptobenzothiazole disulfide (abbreviated to “MBTS”), N-cyclohexyl-2-benzothiazolesulfenamide (abbreviated to “CBS”), N,N-dicyclohexyl-2-benzothiazolesulfenamide (abbreviated to “DCBS”), N-(tert-butyl)-2-benzothiazolesulfenamide (abbreviated to “TBBS”), N-(tert-butyl)-2-benzothiazolesulfenimide (abbreviated to “TBSI”), zinc dibenzyldithiocarbamate (abbreviated to “ZBEC”) and the mixtures of these compounds. Preferably, use is made of a primary accelerator of the sulfenamide type.

Various Additives

The external sidewall composition described above can furthermore comprise the various additives normally present in the external sidewalls known to a person skilled in the art. Mention will be made, for example, of protective agents, such as antioxidants or antiozonants, UV stabilizers, various processing aids or other stabilizers, or else promoters capable of promoting the adhesion to the remainder of the structure of the pneumatic object.

### Preparation of the External Sidewall of the Invention

In order to prepare the external sidewall according to the invention, the elastomers are mixed, in a way known to a person skilled in the art, with the other components of the external sidewall, namely the carbon black, the C₅ resin, the wax, and also the crosslinking system and the optional other ingredients. A person skilled in the art will know how to adapt the order of incorporation of the ingredients (all at once or in several successive stages), the temperature and the compounding time.

Thus, for example, the following procedure is used for the tests: the elastomers, the carbon black, the C₅ resin, the wax and also the optional other ingredients, with the exception of the crosslinking system, are successively introduced into an internal mixer, approximately 70% (plus or minus 5%) filled and for which the initial vessel temperature is between 40° C. and 80° C. Thermomechanical working (non-productive phase) is then carried out in a stage which lasts in total approximately from 3 to 4 minutes, until a maximum “dropping” temperature of 150° C. is reached.

The mixture thus obtained is recovered and cooled and then the crosslinking system, for example sulfur, and an accelerator are incorporated on an external mixer (homofinisher) at 30° C., everything being mixed (productive phase) for an appropriate time (for example between 5 and 12 min).

According to another embodiment, all the components, including the crosslinking system, can be introduced successively into the internal mixer as described above. In this case, the mixing has to be carried out up to a “dropping” temperature of less than or equal to 130° C., preferably of less than or equal to 120° C. and in particular of less than or equal to 110° C.

In some alternative embodiments, one or more of the elastomers (diene and/or thermoplastic) used in the composition can be introduced in the form of a masterbatch or premixed with some of the components of the composition.

The compositions thus obtained are subsequently calendered, either in the form of plaques (thickness from 2 to 3 mm) or thin sheets of rubber, for the measurement of their physical or mechanical properties, or extruded in the form of tyre external sidewalls.

### Use of the External Sidewall in a Pneumatic Tyre

The external sidewall described above is particularly well suited to use as finished or semi-finished product made of rubber, very particularly in a pneumatic tyre for a motor vehicle, such as a vehicle of two-wheel, passenger vehicle or industrial type.

It will be easily understood that, according to the specific fields of application, the dimensions and the pressures involved, the embodiment of the invention can vary; the external sidewall then comprises several preferred embodiments.

### II. EXEMPLARY EMBODIMENTS OF THE INVENTION

The external sidewall described above can advantageously be used in pneumatic tyres for all types of vehicles, in particular passenger vehicles or industrial vehicles, such as heavy-duty vehicles.

By way of example, the single appended figure represents very diagrammatically (without observing a specific scale) a radial section of a pneumatic tyre in accordance with the invention.

This pneumatic tyre 1 comprises a crown 2 reinforced by a crown reinforcement or belt 6, two external sidewalls 3 and two beads 4, each of these beads 4 being reinforced with a bead wire 5. The crown 2 is surmounted by a tread, not represented in this diagrammatic figure. A carcass reinforcement 7 is wound around the two bead wires 5 in each bead 4, the turn-up 8 of this reinforcement 7 being, for example, positioned towards the outside of the tyre 1, which is represented here fitted onto its wheel rim 9. The carcass reinforcement 7 is, in a way known per se, formed of at least one ply reinforced by “radial” cords, for example made of textile or metal, that is to say that these cords are positioned virtually parallel to one another and extend from one bead to the other so as to form an angle of between 80° and 90° with the median circumferential plane (plane perpendicular to the axis of rotation of the tyre which is located midway between the two beads 4 and passes through the middle of the crown reinforcement 6).

The internal wall of the pneumatic tyre 1 comprises an airtight layer 10, for example with a thickness equal to approximately 0.9 mm, on the side of the internal cavity 11 of the pneumatic tyre 1.

The pneumatic tyre according to the invention can use, for example for the composition of its external sidewall as defined above, a composition in accordance with the present invention.

The tyre provided with its external sidewall as described above is preferably produced before crosslinking (or curing). The crosslinking is subsequently carried out conventionally.

An alternative manufacturing form which is advantageous, for a person skilled in the art of pneumatic tyres, will consist, for example during a first stage, in depositing the airtight layer flat directly on a tyre-building drum, in the form of a skim of suitable thickness, before covering the latter with the remainder of the structure of the pneumatic tyre, according to manufacturing techniques well known to a person skilled in the art.

Tests

The properties of the elastomer compositions and of some of their constituents are characterized as indicated below.

Measurement of Mooney Plasticity

The plasticity is measured according to Standard ASTM D1646. The plasticity value is an indicative criterion of the industrial performance.

Measurements of the Rolling Resistance Performance: Dynamic Properties (Dynamic Shear Modulus G* and Loss Modulus G″)

The dynamic properties G*and G″ are measured on a viscosity analyser (Metravib VA4000) according to Standard ASTM D5992-96. The response of a sample of vulcanized composition (cylindrical test specimen with a thickness of 2 mm and a cross section of 79 mm²), subjected to a simple alternating sinusoidal shear stress, at a frequency of 10 Hz, under the standard temperature conditions (23° C.) according to Standard ASTM D1349-09, is recorded. A peak-to-peak strain amplitude sweep is carried out from 0.1% to 50% (outward cycle) and then from 50% to 0.1% (return cycle). The result made use of is the loss modulus G″. For the return circle, the value of G″ at 10% or 20% strain is indicated. The performance index is the ratio of the G″ value of the reference composition to the G″ value of the example considered. As the reference has an index of 100, a value of greater than 100 indicates a better rolling resistance performance.

Measurement of the Ozone Performance

The ozone resistance of the materials is measured according to the following method: after curing, 10 test specimens are placed on a trapezium at different elongations ranging from 10% to 100% in steps of 10% elongation. The “B15” test specimens result from an MFTR (known as Monsanto) plaque, the two beads of which located at the ends are used to hold the test specimen. The “B15” test specimens have the following dimensions 78.5 mm*15 mm*1.5 mm. After exposure for 192 hours to a temperature of 38° C. and to an ozone content of 50 pphm (parts per hundred million), the facies of each of the test specimens is graded as a function of the number and of the depth of the cracks. This subjective grading ranges from 0 to 5 (0: no cracks; 1 to 4: presence of increasingly large and deep cracks; 5: breaking of the test specimen). The mean of the gradings of all the deformations (the lower the mean, the better the ozone performance) is selected as classification criterion.

Measurement of the Efflorescence Performance

After an operation of cutting out from the plaques of cured mixture, the test specimens with a thickness of 2.5 mm are stoved at 70° C. under air for 12 h. They are subsequently stoved at 40° C. under air for 4 weeks. After exiting from the stove and exposing to ambient temperature for 15 min, two successive mechanical stimuli are applied so as to reveal the efflorescence of the wax. In the present case, the first mechanical stimulus consists of an operation of scraping the test specimen with a metal blade. The second mechanical stimulus consists of an elongation of the test specimen to 100% strain. The extent of the efflorescence phenomenon (white colouration of the surface) is subsequently evaluated by means of a subjective scale of values which is representative of the final appearance of the samples. The values of this subjective scale which were respectively obtained for the tested samples can vary from 0 to 3 and correspond to the “efflorescence grading”. These values, ranging from 0 to 3, correspond to the following aspects for the samples:

0—No efflorescence. The scraped surface remains black.
1—Light efflorescence.
2—Moderate efflorescence.
3—Total efflorescence. The scraped surface is white.

The lower the value, the better the appearance of the efflorescence performance, that is to say the weaker the efflorescence.

### Tests on the Compositions

### Example 1

External sidewall compositions containing ordinary elastomers, reinforcing fillers and ordinary additives corresponding to the controls (C1 to C5, Table 1) were prepared according to the methods known to a person skilled in the art and similarly to the preparation of the compositions of the invention described above. These control compositions were compared with compositions (I1 to I3 of Table 1) in accordance with the invention.

All of the compositions of Example 1 are presented in Table 1. The contents are all expressed in phr.

TABLE 1

| | I1 | I2 | I3 | C1 | C2 | C3 | C4 | C5 |
|---|---|---|---|---|---|---|---|---|
| NR (1) | 50 | 50 | 50 | 50 | 50 | 50 | 50 | 50 |
| BR (2) | 50 | 50 | 50 | 50 | 50 | 50 | 50 | 50 |
| Carbon | 50 | 50 | 50 | 50 | 50 | 50 | 50 | 50 |
| black (3) | | | | | | | | |
| Oil (4) | | 10 | | 20 | | 20 | 20 | |
| C₅ resin (5) | 20 | 10 | | | | | | |
| C₅-C₉ resin (6) | | | 20 | | | | | |
| Phenolic | | | | | | | | 20 |
| resin (7) | | | | | | | | |
| Antioxidant (8) | 3 | 3 | 3 | 3 | 3 | 3 | 3 | 3 |
| Anti-ozone | 1.5 | 1.5 | 1.5 | 1.5 | 1.5 | | 1 | 1.5 |
| wax (9) | | | | | | | | |
| Stearic acid | 1.1 | 1.1 | 1.1 | 1.1 | 1.1 | 1.1 | 1.1 | 1.1 |
| Zinc oxide | 2.5 | 2.5 | 2.5 | 2.5 | 2.5 | 2.5 | 2.5 | 2.5 |
| Accelerator (10) | 1.4 | 1.4 | 1.4 | 1.4 | 1.4 | 1.4 | 1.4 | 1.4 |
| Sulfur | 1.4 | 1.4 | 1.4 | 1.4 | 1.4 | 1.4 | 1.4 | 1.4 |

(1) NR Natural rubber
(2) Nd Butadiene rubber
(3) Carbon black N683 (BET equal to 36 m²/g; COAN 85 ml/100 g)
(4) MES oil from Exxon Mobil
(5) C₅ Resin, Escorez 1102 from Exxon (0% aromatic H, 3% ethylenic H, Tg = 53° C., Mn = 900 g/mol, PI = 2.6)
(6) C₅-C₉ Resin, Piccotac 8090 from Eastman (12% aromatic H, 3% ethylenic H, Tg = 40° C., Mn = 940 g/mol, PI = 1.67)
(7) Octylphenol/formaldehyde resin SP1068 from SI Group
(8) 6PPD: N-(1,3-Dimethylbutyl)-N′-phenyl-para-phenylenediamine
(9) Anti-ozone wax, Varazon 4959 from Sasol
(10) N-Cyclohexyl-2-benzothiazolesulfenamide, Santocure CBS from Solutia

The compositions were tested according to the tests described above for efflorescence performance, ozone performance, rolling resistance performance and processability.

All of the results of Example 1 are presented in Table 2.

TABLE 2

| | I1 | I2 | I3 | C1 | C2 | C3 | C4 | C5 |
|---|---|---|---|---|---|---|---|---|
| Efflorescence | 0 | 0 | 1 | 3 | 3 | 0 | 3 | 1 |
| performance | | | | | | | | |
| Ozone | 2.5 | 2.5 | 1.9 | 2.4 | 2.6 | 3.8 | 3.8 | 0.9 |
| performance | | | | | | | | |
| Rolling | 100 | 108 | 107 | 109 | 72 | 112 | 111 | 66 |
| resistance | | | | | | | | |
| performance | | | | | | | | |
| Processability | 68 | 67 | 70 | 64 | 106 | 64 | 65 | 67 |
| (Mooney) | | | | | | | | |

The results presented in Table 2 show that only the compositions I1, I2 and I3 in accordance with the invention make it possible to prevent the efflorescence with an optimum balance between the performance qualities measured.

### Example 2

External sidewall compositions containing ordinary elastomers, reinforcing fillers and ordinary additives corresponding to the controls (C6 to C11, Table 3) were prepared according to the methods known to a person skilled in the art and similarly to the preparation of the compositions of the invention described above. These control compositions were compared with compositions (14 to 17 of Table 3) in accordance with the invention.

All of the compositions of Example 2 are presented in Table 3. The contents are all expressed in phr.

TABLE 3

| | I4 | I5 | I6 | I7 | C6 | C7 | C8 | C9 | C10 | C11 |
|---|---|---|---|---|---|---|---|---|---|---|
| NR (1) | 50 | 50 | 50 | 50 | 50 | 50 | 50 | 50 | 50 | 50 |
| BR (2) | 50 | 50 | 50 | 50 | 50 | 50 | 50 | 50 | 50 | 50 |
| Carbon black (3) | | | 25 | 25 | 25 | | 25 | 25 | 25 | 25 |
| Carbon black (4) | 25 | 25 | | | | 25 | | | | |
| Oil (5) | | | | | 10 | 10 | | 10 | 10 | |
| C₅ resin (6) | 10 | | 10 | | | | | | | |
| C₅-C₉ resin (7) | | 10 | | 10 | | | | | | |
| Phenolic resin (8) | | | | | | | | | | 10 |
| Antioxidant (9) | 3 | 3 | 3 | 3 | 3 | 3 | 3 | 3 | 3 | 3 |
| Anti-ozone wax (10) | 1.5 | 1.5 | 1.5 | 1.5 | 1.5 | 1.5 | 1.5 | | 1 | 1.5 |
| Stearic acid | 1 | 1 | 1 | 1 | 1 | 1 | 1 | 1 | 1 | 1 |
| Zinc oxide | 2.5 | 2.5 | 2.5 | 2.5 | 2.5 | 2.5 | 2.5 | 2.5 | 2.5 | 2.5 |
| Accelerator (11) | 1.4 | 1.4 | 1.4 | 1.4 | 1.4 | 1.4 | 1.4 | 1.4 | 1.4 | 1.4 |
| Sulfur | 1.4 | 1.4 | 1.4 | 1.4 | 1.4 | 1.4 | 1.4 | 1.4 | 1.4 | 1.4 |

(1) NR Natural rubber
(2) BR Nd Butadiene rubber
(3) Carbon black SR401 from Sid Richardson (BET 62 m²/g; COAN 107 ml/100 g)
(4) Mixture of carbon blacks, 60% of N347 (BET 88 m²/g; COAN 98 ml/100 g) and 40% of N683 (BET equal to 36 m²/g; COAN 85 ml/100 g)
(5) MES oil from Exxon Mobil
(6) C₅ Resin, Escorez 1102 from Exxon
(7) C₅-C₉ Resin, Piccotac 8090 from Eastman
(8) Octylphenol/formaldehyde resin SP1068 from SI Group
(9) 6PPD: N-(1,3-Dimethylbutyl)-N′-phenyl-para-phenylenediamine
(10) Anti-ozone wax, Varazon 4959 from Sasol
(11) N-Cyclohexyl-2-benzothiazolesulfenamide, Santocure CBS from Solutia

The compositions were tested according to the tests described above for efflorescence performance, ozone performance, rolling resistance performance and processability.

All of the results of Example 2 are presented in Table 4.

TABLE 4

| | I4 | I5 | I6 | I7 | C6 | C7 | C8 | C9 | C10 | C11 |
|---|---|---|---|---|---|---|---|---|---|---|
| Efflorescence | 0 | 0 | 1 | 1 | 3 | 3 | 3 | 0 | 2 | 1 |
| performance | | | | | | | | | | |
| Ozone performance | 2.5 | 2.6 | 2.1 | 2.2 | 2.4 | 2.4 | 3.9 | 3.9 | 3.7 | 2.8 |
| Rolling resistance | | | | | | | | | | |
| performance | 100 | 101 | 103 | 103 | 106 | 101 | 86 | 105 | 106 | 76 |
| Processability | 60 | 61 | 61 | 62 | 59 | 60 | 82 | 59 | 60 | 63 |
| (Mooney) | | | | | | | | | | |

The results presented in Table 4 show that only the compositions 14, 15, 16 and 17 in accordance with the invention make it possible to prevent the efflorescence with an optimum balance between the performance qualities measured.

### Example 3

External sidewall compositions containing ordinary elastomers, reinforcing fillers and ordinary additives corresponding to the controls (C12 to C16, Table 5) were prepared according to the methods known to a person skilled in the art and similarly to the preparation of the compositions of the invention described above. These control compositions were compared with compositions (I8 to I10 of Table 5) in accordance with the invention.

All of the compositions of Example 3 are presented in Table 5. The contents are all expressed in phr.

TABLE 5

| | I8 | I9 | I10 | C12 | C13 | C14 | C15 | C16 |
|---|---|---|---|---|---|---|---|---|
| NR (1) | 50 | 50 | 50 | 50 | 50 | 50 | 50 | 50 |
| BR (2) | 50 | 50 | 50 | 50 | 50 | 50 | 50 | 50 |
| Carbon | | | 35 | | | | | |
| black (3) | | | | | | | | |
| Carbon | 35 | 35 | | 35 | 35 | 35 | 35 | 35 |
| black (4) | | | | | | | | |
| Oil (5) | | | | 10 | | 10 | 10 | |
| C₅ resin (6) | 10 | | | | | | | |
| C₅-C₉ resin (7) | | 10 | 10 | | | | | |
| Phenolic | | | | | | | | 10 |
| resin (8) | | | | | | | | |
| Antioxidant (9) | 3 | 3 | 3 | 3 | 3 | 3 | 3 | 3 |
| Anti-ozone | 1.5 | 1.5 | 1.5 | 1.5 | 1.5 | | 1 | 1.5 |
| wax (10) | | | | | | | | |
| Stearic acid | 1.5 | 1.5 | 1.5 | 1.5 | 1.5 | 1.5 | 1.5 | 1.5 |
| Zinc oxide | 2.5 | 2.5 | 2.5 | 2.5 | 2.5 | 2.5 | 2.5 | 2.5 |
| Accelerator | 1 | 1 | 1 | 1 | 1 | 1 | 1 | 1 |
| (11) | | | | | | | | |
| Sulfur | 1.6 | 1.6 | 1.6 | 1.6 | 1.6 | 1.6 | 1.6 | 1.6 |

(1) NR Natural rubber
(2) BR Nd Butadiene rubber
(3) Carbon black N683 (BET equal to 36 m²/g; COAN 85 ml/100 g)
(4) Carbon black N234 (BET 119 m²/g; COAN 102 ml/100 g)
(5) MES oil from Exxon Mobil
(6) C₅ Resin, Escorez 1102 from Exxon
(7) C₅-C₉ Resin, Piccotac 8090 from Eastman
(8) Octylphenol/formaldehyde resin SP1068 from SI Group
(9) 6PPD: N-(1,3-Dimethylbuty1)-N′-phenyl-para-phenylenediamine
(10) Anti-ozone wax, Varazon 4959 from Sasol
(11) N-Cyclohexy1-2-benzothiazolesulfenamide, Santocure CBS from Solutia

The compositions were tested according to the tests described above for efflorescence performance, ozone performance, rolling resistance performance and processability.

All of the results of Example 3 are presented in Table 6.

TABLE 6

| | I8 | I9 | I10 | C12 | C13 | C14 | C15 | C16 |
|---|---|---|---|---|---|---|---|---|
| Efflorescence | 0 | 1 | 0 | 3 | 3 | 0 | 1 | 1 |
| performance | | | | | | | | |
| Ozone | 0.8 | 0.4 | 0.3 | 0.1 | 0.0 | 4.7 | 3.5 | 2.9 |
| performance | | | | | | | | |
| Rolling resistance | 100 | 97 | 160 | 98 | 80 | 107 | 95 | 72 |
| performance | | | | | | | | |
| Processability | 66 | 66 | 53 | 62 | 83 | 70 | 67 | 63 |
| (Mooney) | | | | | | | | |

The results presented in Table 6 show that only the compositions I8, I9 and I10 in accordance with the invention make it possible to prevent the efflorescence with an optimum balance between the performance qualities measured.

1.-25. (canceled)

26. A tire provided with an external sidewall, the external sidewall comprising at least one composition based on at least:
from 30 to 60 phr of isoprene elastomer;
from 40 to 70 phr of butadiene elastomer;
from 10 to 70 phr of carbon black;
from 5 to 25 phr of hydrocarbon resin predominantly composed of units resulting from C₅ monomers;
from 1.2 to 10 phr of anti-ozone wax; and
a crosslinking system.

27. The tire according to claim 26, wherein the content of isoprene elastomer is within a range extending from 30 to 55 phr.

28. The tire according to claim 26, wherein the isoprene elastomer is selected from the group consisting of natural rubber, synthetic polyisoprenes and mixtures thereof.

29. The tire according to claim 26, wherein the isoprene elastomer consists of natural rubber.

30. The tire according to claim 26, wherein the content of butadiene elastomer is within a range extending from 45 to 70 phr.

31. The tire according to claim 26, wherein the butadiene elastomer is selected from the group consisting of polybutadienes, butadiene/styrene copolymers and mixtures thereof.

32. The tire according to claim 26, wherein the butadiene elastomer is selected from the group consisting of polybutadienes and mixtures thereof.

33. The tire according to claim 26, wherein the carbon black exhibits a specific surface of greater than 60 m²/g.

34. The tire according to claim 26, wherein the carbon black exhibits a specific surface of greater than 90 m²/g.

35. The tire according to claim 26, wherein a total amount of carbon black is within a range extending from 20 to 60 phr.

36. The tire according to claim 26, wherein the hydrocarbon resin exhibits an aromatic proton content of less than 20%.

37. The tire according to claim 26, wherein the hydrocarbon resin exhibits an aromatic proton content of less than 5%.

38. The tire according to claim 26, wherein the hydrocarbon resin does not comprise an aromatic unit.

39. The tire according to claim 26, wherein the hydrocarbon resin exhibits an aromatic proton content within a range extending from 7% to 15%.

40. The tire according to claim 26, wherein the hydrocarbon resin exhibits an ethylenic proton content of less than 15%.

41. The tire according to claim 26, wherein the hydrocarbon resin exhibits a glass transition temperature within a range extending from 30° C. to 80° C.

42. The tire according to claim 26, wherein the hydrocarbon resin exhibits a number-average molecular mass within a range extending from 500 to 3000 g/mol.

43. The tire according to claim 26, wherein the hydrocarbon resin exhibits a polydispersity index within a range extending from 1 to 4.

44. The tire according to claim 26, wherein the amount of hydrocarbon resin is within a range extending from 7 to 25 phr.

45. The tire according to claim 26, wherein the anti-ozone wax contains from 50% to 75% of linear alkanes comprising from 30 carbon atoms to 38 carbon atoms, with respect to the total amount of linear alkanes.

46. The tire according to claim 26, wherein the amount of anti-ozone wax is within a range extending from 1.3 to 5 phr.

47. The tire according to claim 26, wherein the at least one composition does not comprise a plasticizing oil.

48. The tire according to claim 26, wherein the at least one composition further comprises a plasticizing oil.

49. The tire according to claim 48, wherein the plasticizing oil is selected from the group consisting of naphthenic oils, paraffinic oils, MES oils, TDAE oils, mineral oils, vegetable oils, ether plasticizers, ester plasticizers, phosphate plasticizers, sulfonate plasticizers and mixtures thereof.

50. The tire according to claim 48, wherein an amount of plasticizing oil is within a range extending from more than 0 to 25 phr.
